(19) United States
(12) Patent Application Publication
(10) Pub. No.: US 2015/0364775 A1
(43) Pub. Date: Dec. 17, 2015

(54) FUEL CELL SEPARATOR, AND FUEL CELL COMPRISING THE SAME

(71) Applicants: Hyundai Motor Company, Seoul (KR); Kia Motors Corporation, Seoul (KR)

(72) Inventor: Sang Mun Jin, Yongin (KR)

(21) Appl. No.: 14/549,122

(22) Filed: Nov. 20, 2014

(30) Foreign Application Priority Data
Jun. 11, 2014 (KR) 10-2014-0070966

(51) Int. Cl. H01M 8/02

(52) U.S. Cl. CPC H01M 8/0263

(57) ABSTRACT

A fuel cell separator and a fuel cell including the fuel cell separator are provided. The fuel cell separator includes a plurality of channels and inlets and outlets formed through first sides and second sides of the channels such that the reactant introduced into the channels flows perpendicularly to the channels. In particular, the inlets are positioned higher than the outlets.

### CROSS REFERENCE TO RELATED APPLICATION

The present application claims priority of Korean Patent Application Number 10-2014-0070966 filed on Jun. 11, 2014, the entire contents of which application are incorporated herein for all purposes by this reference.

### TECHNICAL FIELD

The present invention relates to a fuel cell separator and a fuel cell including the same. and, more particularly, to a fuel cell separator that improves diffusion ability and reaction efficiency of a reactant by guiding the reactant perpendicularly to the longitudinal sides of channels formed in the separator.

### BACKGROUND

Typically, when a metal separator is applied to a fuel cell, the structures thereof include a metal separator which has channels for a reactant and cooling water, a pair of gas diffusion layers (GDL) for facilitating the diffusion of the reactant and membrane electrode assembly (MEA) which generates a chemical reaction and is disposed between the gas diffusion layers.

In general, in each separator, channels through which a reactant flows in the same direction as the flow of cooling water and lands which are in contact with the GDLs are formed repeatedly. The channels of an anode separator and a cathode separator are symmetrical, so the space between the separators is used as a cooling channel.

Further, to increase the performance of fuel cells, it may be desired to make the surface pressure applied more uniformly on the GDLs and the MEA by reducing the channel gap in the separators and to provide the GDLs substantially constant transmission throughout the reacting surface. However, reducing the channel gap in the separators may be limited due to defects such as crack and spring backcaused during manufacturing. In addition, other problems may deteriorate performance.

For example, diffusion of a reactant and discharging of produced water may decrease. When channel pitches are substantially large, stress may concentrate on lands which are in contact between the separator and GDLs, thus causing non-uniform surface pressure. Accordingly, the porous structure of the GDLs may be destroyed and transmission in the GDL may deteriorate such that the ability to diffuse a reactant and to discharge produced water may decrease. Further, as stress in a channel is reduced, the GDLs may penetrate into the channel, thereby inhibiting fluidity of the reactant. In addition, electrode membrane may be damaged when carbon fibers penetrate an electrode membrane at the lands portion of the destroyed GDL.

Furthermore, non-uniformity of electric conductivity may occur. In the channel where the GDLs are exposed, a reactant may be adequately supplied and a chemical reaction may be actively generated. Meanwhile, contact resistance may increase due to insufficient surface pressure between the GDLs and the MEA, such that electrons created by the reaction may not be move to collectors.

The foregoing is intended merely to aid in the understanding of the background of the present invention, and is not intended to mean that the present invention falls within the purview of the related art that is already known to those skilled in the art.

### SUMMARY

The present invention provides a fuel cell separator having channels formed perpendicularly to the flow of a reactant, a plurality of apertures formed along the sides of the channels to form flow paths for the reactant. In particular, the apertures for inflow and outflow of the reactant may be formed at different heights. In another aspect, a fuel cell including the fuel cell separator is provided.

In an exemplary embodiment, a fuel cell separator may include: a plurality of channels; and inlets and outlets formed along first sides and second sides of the channels such that a reactant introduced into the channels flows perpendicularly to the channels. Particularly, in the channels, the inlets may be positioned higher than the outlets.

The inlets and the outlets may not be positioned on same lines. In particular, the inlets and the outlets may be formed along first and second longitudinal sides of the channels respectively, and may be formed at a predetermined distance from each other. A center point of the inlet may be positioned higher than a center point of the outlet. The separator may be bent in a zigzag shape having bent tops and bent bottoms. Accordingly, a catalytic layer which may be further provided in a fuel cell may be in contact with lower surfaces of bent bottoms of the separator, and the channels may be formed as closed-sections between the separator and the catalytic layer.

A substantially center point of the inlet may be positioned higher a center point between the catalytic layer and the bent top of the separator. A center point of the outlet may be positioned lower (e.g., below) than a center point between the catalytic layer and the bent top of the separator. The inlet may extend to the bent top of the separator so that the bent top of the separator may include a portion of the inlet The outlet may extend to the bent bottom of the separator so that the bent bottom of the separator may include a portion of the outlet. The separator may be formed in a zigzag shape and a panel which may be in contact with bent tops of the separator may be disposed on top of the separator.

In another exemplary embodiment, a fuel cell may include the fuel cell separator having the structure described above. In particular, since the inlets and the outlets of the fuel cell separator may be arranged alternately and not on the same lines, diffusion of a reactant in the fuel cell may be improved and the reaction efficiency with the catalytic layer of the fuel cell may increase. According to various exemplary embodiments, by making a height difference between the inlets and the outlets, reaction efficiency between the reactant flowing inside through the inlets and the catalytic layer may be substantially improved.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 illustrates an exemplary fuel cell separator and an exemplary fuel cell including the fuel cell separator according to an exemplary embodiment of the present invention;

FIG. 2 is a plan view of an exemplary fuel cell separator according to an exemplary embodiment of the present invention;

FIG. 3 is a cross-sectional view of the exemplary fuel cell separator taken along line A-A of FIG. 1 according to an exemplary embodiment of the present invention;

FIG. 4 is a cross-sectional view of the exemplary fuel cell separator taken along line B-B of FIG. 1 according to an exemplary embodiment of the present invention;

FIG. 5 illustrates an exemplary flow of a reactant in the cross-section of the exemplary fuel cell separator taken along line A-A of FIG. 1 according to an exemplary embodiment of the present invention;

FIG. 6 illustrates an exemplary flow of a reactant in the cross-section of the exemplary fuel cell separator taken along line B-B of FIG. 1 according to an exemplary embodiment of the present invention; and

FIG. 7 is a diagram comparing voltage outputs of an exemplary fuel cell according to height differences of an inlet and an outlet in an exemplary embodiment of the present invention.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

A fuel cell separator and a fuel cell including the fuel cell separator according to various embodiments of the present invention will described hereafter with reference to the accompanying drawings.

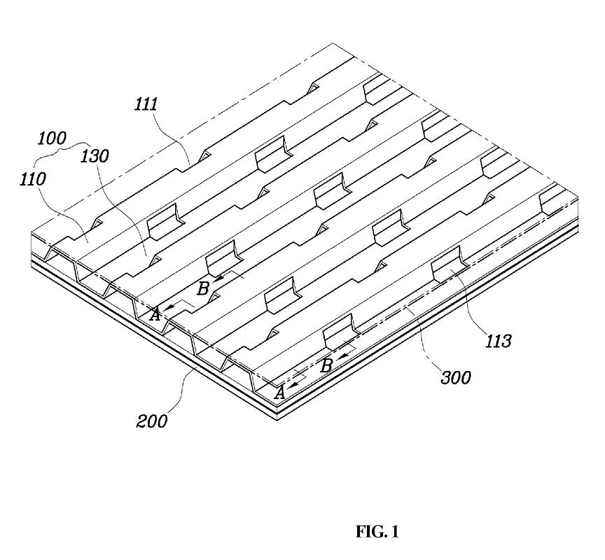

FIG. 1 illustrates an exemplary fuel cell separator and an exemplary fuel cell including the fuel cell separator according to an exemplary embodiment of the present invention. A fuel cell separator 100 in FIG. 1 may include: a plurality of channels 110; and inlets 111 and outlets 113 formed along first sides and second sides of the channels 110 such that a reactant introduced into the channels 110 may flow perpendicularly to the longitudinal side channels 110. In particular, the inlets 111 may be positioned higher (e.g., at a higher level or above) than the outlets 113.

According to an exemplary fuel cell according to an exemplary embodiment of the present invention, the separator 100 may be bent in a zigzag shape having bent tops and bent bottoms and a catalytic layer 200 being in contact with the lower surfaces of the bent bottoms of the separator 100 may be further included. Particularly, the channels 110 formed between the separator 100 and the catalytic layer 200 may be closed-sections.

Further, a panel 300 in contact with the bending tops of the separator 100 may include sub-channels 130 formed by closed-sections between the separator 100 and the panel 300. The panel 300 may prevent a reactant flowing through the inlets 111 and the outlets 113 from leaking and may maintain airtightness (e.g., an air seal) between fuel cells. The catalytic layer 200 may be composed of a membrane electrode assembly (MEA) and a pair of gas diffusion layers (GDLs) on both sides of the MEA. The catalytic layer 200 may include an MEA. Without being bound to certain examples, various exemplary embodiments may be applied as the catalytic layer 200 without limitation.

The inlets 111 and the outlets 113 may be formed as apertures through the first sides and the second sides of the channels 110, such that a reactant introduced inside through the inlets 111 may be discharged to the outlets 113 through the channels 110 and a reactant moving along the sub-channels 130 may flow into adjacent channels 110 through their inlets 111. The reactant may include at least any one of hydrogen gas, air, cooling water and may also be other reactants not including them. In particular, the inlet 111 and the outlet 113 may not be positioned on the same line, respectively, to improve diffusion of a reactant. In other words, as described above, a reactant introduced inside through an inlet 111 may pass for a predetermined distance along a channel 111 and then flow outside through an outlet 113, such that the reactant may stay in the channel 110, to increase reaction efficiency with the catalytic layer 200. The term “line” as used hererin, refers to a perpendicular line to the channels 110.

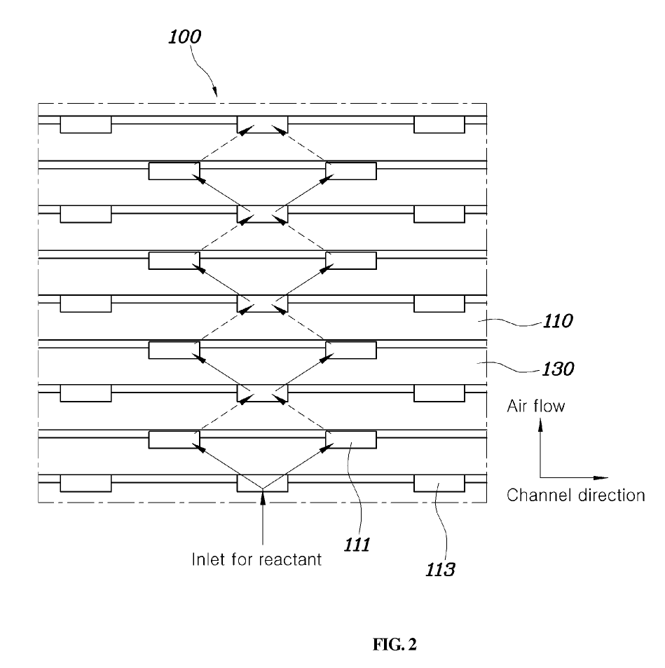

FIG. 2 is a plan view of an exemplary fuel cell separator 100 according to an exemplary embodiment of the present invention. FIG. 2 shows the arrangement of the inlets 111 and the outlets 113 and flow of a reactant. A plurality of inlets 111 and the outlets 113 may be formed along the longitudinal sides of the channel 110 at the first sides and second sides respectfully, and may be spaced from each other by a predetermined distance. In particular, the inlets 111 and the outlets 113 may be arranged with regular intervals.

The distance between the inlet 111 and the outlet 113 may be a distance between the center points of the inlet 111 and the outlet 113, or may be a distance between adjacent sides in the sides of the inlet 111 and the outlet 113. Alternatively, various examples to determine the distance between the inlet 111 and the outlet 113 may be included in the present invention. In addition, the distance between the inlet 111 and the outlet 113 may be determined by a skilled artisan for the purpose of the invention without any limitation. The inlet 111 and the outlet 113 may be formed in various shapes such as a circle, an ellipse, a rectangle, a diamond, and the like and may be formed in shapes to minimize flow resistance. For instance, shapes may be formed with the corners rounded. The shapes or the areas of the inlet 111 and the outlet 113 may not be identical to each other. Although the areas or the shapes thereof may be different, the positions of the center points of the inlet 111 and the outlet 113 may be differently determined, and the distance between the catalytic layer 200 and the center point of the inlet 111 may be greater than the distance between the catalytic layer 200 and the center point of the outlet 113.

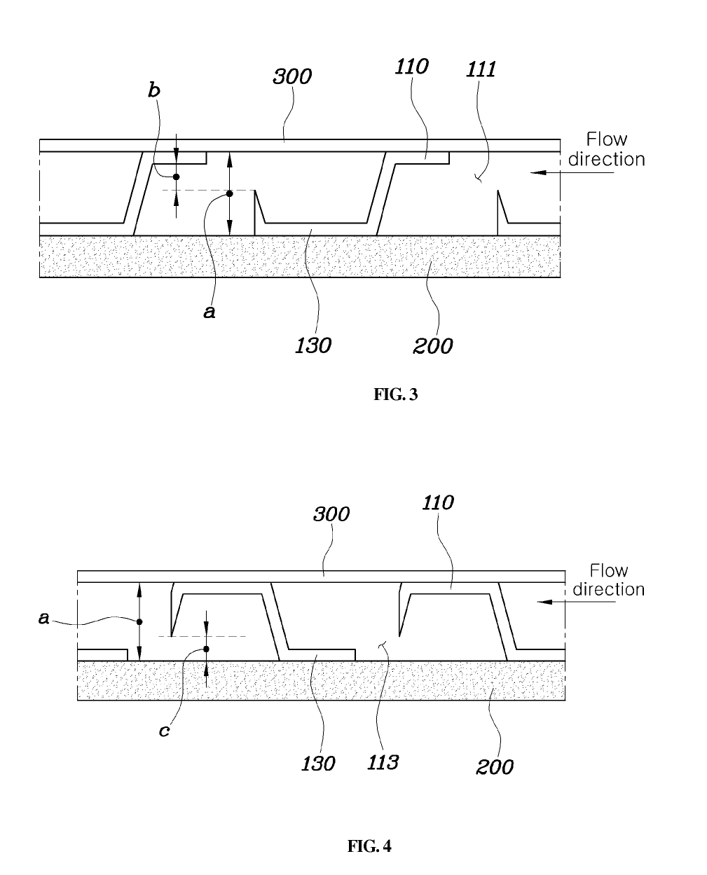

FIG. 3 is a cross-sectional view of an exemplary fuel cell separator taken along line A-A in FIG. 1, showing a cross-section of the inlet 111, and FIG. 4 is a cross-sectional view taken along line B-B of FIG. 1, showing a cross-section of the outlet 113.

In an exemplary embodiment, as shown in FIGS. 3 and 4, the inlet 111 and the outlet 113 may be formed such that the center point b of the inlet 111 may be positioned higher than (e.g., at a higher position or above) the center point c of the outlet 113. The center points b and c refer to substantially middle points of the height differences between the tops and the bottoms of the inlet 111 and the outlet 113, respectively, when drawing a line on the tops and the bottoms in parallel with the catalytic layer 200. Since the inlet 111 may be positioned higher than the outlet 113, a head may be generated, when a reactant flows into and out of the channel 110, potential energy may be converted into kinetic energy by the head, and the reactant may permeate into the catalytic layer 200, as shown in FIG. 5. Accordingly, reaction activity with the catalytic layer 200 may be improved, unlike a reactant which flows on the catalytic layer 200 along the channel 110, as in the related art.

Further, the center point b of the inlet 111 may be positioned higher than the center point a between the catalytic layer 200 and the upper surface of the bent top of the separator 100. In other words, the center point b of the inlet 111 may be positioned higher than the center point a between the catalytic layer 200 and the panel 300. Accordingly, potential energy of a reactant may be generated when the reactant is discharged through the outlet 113 on an adjacent outlet 113 and further, when the reactant flows inside through the inlet 111, the discharged reactant may have potential energy by moving up along the first side of the channel 110, which is lower than (e.g., disposed at a lower position than or below) the inlet 111.

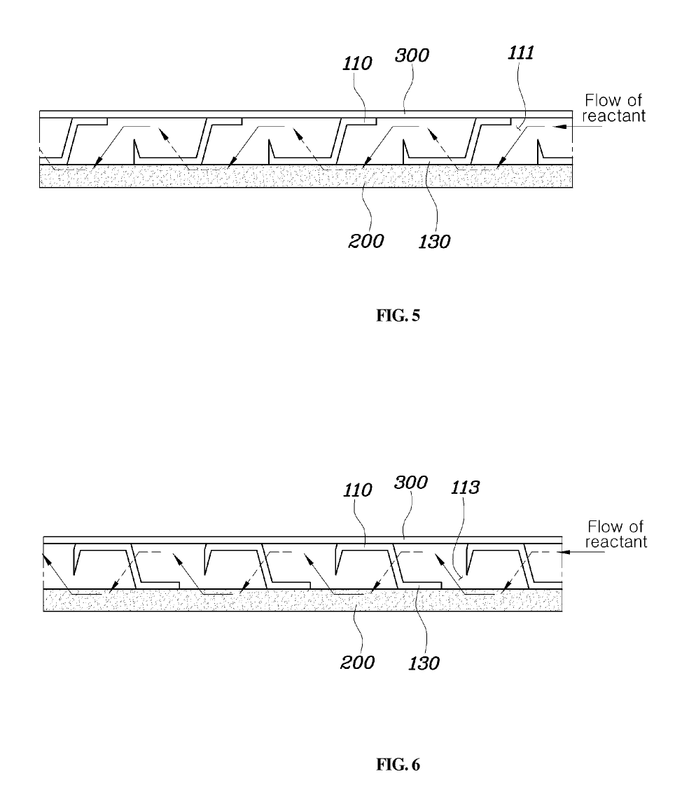

Additionally, the center point c of the outlet 113 may be positioned lower than the center point a between the catalytic layer 200 and the upper surface of the bent top of the separator 100. In other words, the center point c of the inlet 113 may be positioned lower than the center point a between the catalytic layer 200 and the panel 300. Accordingly, as shown in FIG. 6, the reactant which flows inside through the inlet 111 may be guided downward via the second side of the channel 110, above the outlet 113, and the reactant may flow inside to move toward the catalytic layer 200 thereby increasing reactivity between the reactant and the catalytic layer.

Further, as shown in FIGS. 1, 3, and 5, the inlet 111 may extend to the bent top of the separator 100 so that the bending top of the separator 100 may include a portion of the inlet 111, since the reactant discharged through the outlet 113 may flow along a parabolic curve. Accordingly, when the reactant flows into the inlet 111, smooth inflow may be achieved by positioning the bent tops of the separator outside the flow path of the reactant. Moreover, as shown in FIGS. 1, 4, and 6, the outlet 113 may extend to the bent bottom of the separator 100 so that the bending bottom of the separator 100 may include a portion of the outlet 113, since the reactant flowing in the inlet 111 may be discharged along a parabolic curve by the second side of the channel 110, higher than the outlet 113. Thus, when the reactant is discharged to the outlet 113, reactivity between the reactant and the catalytic layer may be improved increasing the contact surface between the catalytic layer 200 and the movement path of the reactant.

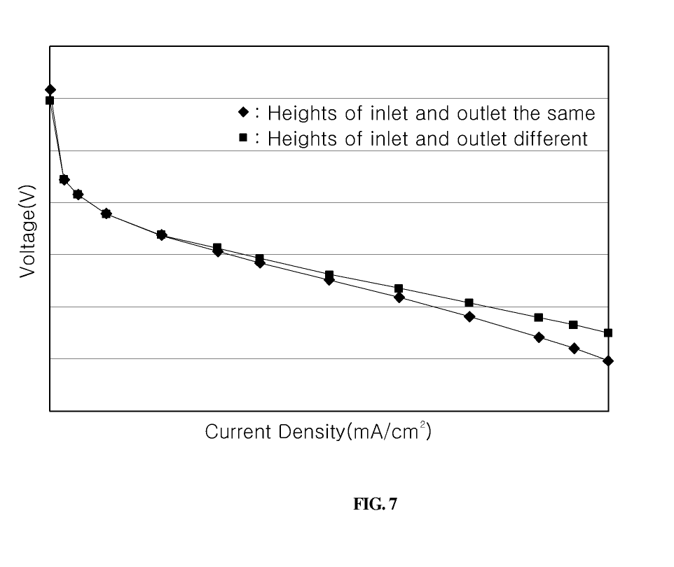

According to various exemplary embodiments of the present invention, the fuel cell including the fuel cell separator as described above may obtain advantages. As shown in FIG. 7, a diagram is shown to compare outputs according to height differences of an inlet and an outlet and greater outputs may be obtained when height differences are formed between the inlet 111 and the outlet 113 than when the inlet and the outlet have the same height due to increased diffusion of the reactant by the flowing into the catalytic layer 200 and increased reactivity.

According to various exemplary fuel cell separators having the structure described above and the fuel cell including the fuel cell separator, since the inlets 111 and the outlets 113 may be formed in alternate arrangement which is not positioned on the same lines, diffusion of a reactant may be improved and the reaction efficiency with the catalytic layer 200 may increase. Further, since a height difference between the inlet 111 and the outlet 113 may be generated, the reaction efficiency between the reactant flowing inside through the inlet 111 and the catalytic layer 200 may be improved.

Although various exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A fuel cell separator, comprising:
a plurality of channels; and
inlets and outlets formed through first sides and second sides of the channels to allow a reactant flowing into the channels to flow perpendicularly to the channels,
wherein the inlets are positioned higher than the outlets.

2. The fuel cell separator of claim 1, wherein the inlets and the outlets are positioned on different lines.

3. The fuel cell separator of claim 2, wherein the inlets and the outlets are formed along longitudinal sides of the channels and are spaced from each other by a predetermined distance.

4. The fuel cell separator of claim 1, wherein a substantially center point of the inlet is positioned higher than a center point of the outlet.

5. A fuel cell comprising a fuel cell separator, wherein the fuel cell separator includes the plurality of channels; and inlets and outlets formed through first sides and second sides of the channels to allow a reactant flowing into the channels to flow perpendicularly to the channels, wherein the inlets are positioned higher than the outlets and the separator is bent in a zigzag shape having bent tops and bent bottoms.

6. The fuel cell of claim 5, further comprising:
a catalytic layer in contact with lower surfaces of the bent bottoms of the fuel cell separator,
wherein the channels are closed-sections between the fuel cell separator and the catalytic layer.

7. The fuel cell of claim 5, wherein a substantially center point of the inlet is positioned higher than a center point between the catalytic layer and the bent top of the fuel cell separator.

8. The fuel cell of claim 5, wherein a substantially center point of the outlets is positioned lower than a center point between the catalytic layer and the bent top of the fuel cell separator.

9. The fuel cell of claim 5, wherein the inlet extends to the bent top of the fuel cell separator so that the bent top of the fuel cell separator includes a portion of the inlet.

10. The fuel cell of claim 5, wherein the outlet extends to the bent bottom of the fuel cell separator so that the bent bottom of the fuel cell separator includes a portion of the outlet.

11. The fuel cell of claim 5, wherein a panel being in contact with bent tops of the fuel cell separator is provided on top of the fuel cell separator.
